(19) United States
(12) Patent Application Publication
(10) Pub. No.: US 2023/0133525 A1
(43) Pub. Date: May 4, 2023

(54) CONTROL SYSTEM AND METHOD FOR FOLLOWER E-PALLET IN LEADER-FOLLOWER PLATOON ARRANGEMENT

(71) Applicant: GM GLOBAL TECHNOLOGY OPERATIONS LLC, Detroit, MI (US)

(72) Inventors: Hojjat Izadi, North York (CA); Carlos E. Arreaza, Oakville (CA); Mohammad-Amin Rajaie, Richmond Hill (CA); Mohammad H. Beheshti, Oshawa (CA)

(73) Assignee: GM GLOBAL TECHNOLOGY OPERATIONS LLC, Detroit, MI (US)

(21) Appl. No.: 17/515,656

(22) Filed: Nov. 1, 2021

(51) Int. Cl. B65D 19/42; B62B 5/00; B62B 5/06

(52) U.S. Cl. CPC B65D 19/42; B62B 5/0043; B62B 5/0079; B62B 5/0069; B62B 5/06; B65D 2519/00781

(57) ABSTRACT

A platoon of electric pallets (e-pallets) includes a follower e-pallet connected to or in wireless communication with a leader e-pallet. The platoon also includes a sensor suite, road wheels, an electric powertrain system, and a local controller. The sensor suite includes a velocity sensor configured to measure a velocity of the follower e-pallet, an angle sensor configured to measure an azimuth angle between the follower and leader e-pallets, and a length or distance sensor configured to measure a distance therebetween. The local controller executes a method to adaptively move a variable target point (VTP) on the leader pallet in response to the velocity, the azimuth angle, and the length, and to thereafter control a dynamic output state of the electric powertrain system using the VTP.

### INTRODUCTION

Manufacturing plants and warehouse facilities require the coordinated movement of raw materials, subcomponents, and finished parts, often over considerable distances. Larger or relatively massive loads may be transported with the assistance of fork lifts, tractors, conveyor belts, and other power equipment. In contrast, smaller loads may be moved by hand or using manually-operated pallet trucks, wheeled dollies, or hand carts. Collectively, machine powered and manually operated lift assistance devices improve overall production efficiency, while at the same time greatly reducing load-related stresses and strains on human operators within the workplace.

Certain operations not requiring the assistance of heavy power equipment of the types described generally above may nevertheless not be suitable for manually-operated devices like hand carts and dollies. In such cases, a human operator may utilize one or more motorized electric pallets (“e-pallets”) each having a superstructure mounted on or integrally formed with a wheeled base platform. One or more electric traction motors provides a drive torque to driven road wheels of the e-pallet to help propel the e-pallet along a floor surface.

### SUMMARY

The present disclosure pertains to methods and systems for controlling motor-driven electric pallets (“e-pallets”) that are lightly tethered together or in wireless communication with one another in a leader-follower platoon arrangement. As used herein, the contemplated platoon arrangement includes one lead e-pallet or another lead vehicle (“leader”) that is serially connected to or in wireless communication with one or more trailing (“follower”) e-pallets, such that the follower e-pallets are located aft of the lead e-pallet when the platoon is in forward motion. As used herein, “lightly tethered” refers to the possible serial linking together of one or more follower e-pallets via an intervening tether device, itself having integral length and angle sensors as set forth below. As appreciated in the art, an alternative wireless or “tether-less” solution may be envisioned to accomplish the same or similar tasks, including pallet pose estimation by calculation/measuring distance, azimuth, and yaw rate using, e.g., radar, ultrasonics, lidar, one or more cameras, ultra-wide band (UWB) communications, etc. Additionally, the platoon contemplated herein is characterized by an absence of vehicle-to-vehicle (V2V) communications between the various e-pallets, such that a given e-pallet does not offload data to another e-pallet in the platoon. The lack of a V2V communications capability gives rise to the local control strategy described herein.

For illustrative simplicity, the local control strategy for implementation aboard each respective of the follower e-pallets is described below with respect to a simplified two-member platoon embodiment, e.g., one in which a single follower is tethered to leader by the tether device to use a consistent non-limiting example configuration. The leader moves autonomously, is driven by an operator, or moves in response to a manual towing force imparted by the operator. Aboard the follower, a local controller optimizes locomotion of the follower using a variable target point (VTP), a variable distance setpoint (VDSP), and velocity estimate (Vest) of the leader. This collective set of information is used in lieu of a static tracking point on the leader so to prevent, among other things, instances of jackknifing, zig-zag turns requiring larger maneuver areas, an inability of the platoon to negotiate tight turns or circuitous hallways, poor tracking performance of the followers relative to the leader, and other possible stability and range of motion issues.

In terms of the VTP, the local controller is programmed to execute computer-readable instructions, with instruction execution causing the local controller to adaptively move the VTP within a given frame of reference, in real-time, to increase the overall stability of the platoon. The VTP is also used to set a desired distance between consecutive followers in embodiments in which more than one follower is used.

The VDSP for its part is also modified in real-time by the local controller based on an angle of articulation or azimuth angle between an axis of the leader, e.g., the tether device, and a leading edge of the follower. Modification of the VDSP is performed by the local controller to adapt to a limited range of motion of the tether device. The velocity of the leader in turn is estimated by the local controller and thereafter used to define a desired velocity of the follower. In this manner, the present local control strategy enables sharper cornering of the entire platoon without an accompanying loss of stability.

In a particular embodiment, a platoon of e-pallets includes a leader e-pallet and a follower e-pallet connected to or in wireless communication with the leader e-pallet to form the platoon of e-pallets, with the followers located aft of the leader. An axis of the leader, in this instance its longitudinal center axis, is arranged at an azimuth angle with respect to the follower. The platoon also includes a sensor suite, including a velocity sensor configured to measure a velocity of the follower, an angle sensor configured to measure the azimuth angle, and a length sensor configured to measure a distance from the follower to the leader. Such a distance could be a length of a tether device in the exemplary tethered embodiment.

The follower in this configuration includes a set of road wheels, an electric powertrain system connected to the set of road wheels and configured to provide an output torque thereto, and a local controller connected to the follower. The local controller is configured to adaptively move a VTP on the leader in response to the velocity, the azimuth angle, and the distance/length, and to thereafter control a dynamic output state of the electric powertrain system using the VTP.

The local controller may change a variable distance setpoint on the leader based on the azimuth angle to maintain a linear distance between the leader and follower.

In an aspect of the disclosure, the local controller may estimate a velocity of the leader as an estimated velocity, define a desired velocity of the follower using the estimated velocity, and thereafter control the dynamic output state of the electric powertrain system of the follower using the estimated velocity.

The length or distance sensor may include a string potentiometer or a wireless proximity sensor.

The leader in some implementations is configured to be towed by a human operator via another tether device, and the leader includes motorized drive wheels responsive to a towing force imparted by the human operator.

The set of road wheels may include a pair of front drive wheels. The electric powertrain system may include first and second electric motors respectively connected to a different one of the front drive wheels to provide the follower e-pallet with a differential steering capability.

In a possible embodiment, the local controller is configured to use a velocity term to provide a faster response at higher velocities of the platoon to enable the local controller, and to compensate for a relatively slow response of the optional tether device.

In the various embodiments set forth above, the follower may include a plurality of followers, i.e., one behind another.

In another aspect of the present disclosure, a method for controlling the platoon of e-pallets includes measuring, via a plurality of sensors of a sensor suite, a velocity of the follower e-pallet, an azimuth angle defined between a tether device and a leading edge of the follower e-pallet, and a length sensor configured to measure a length of the tether device. The method also includes adaptively moving a VTP on the leader pallet, via a local controller of the follower e-pallet, in response to the velocity, the azimuth angle, and the length. The method thereafter includes controlling a dynamic output state of the electric powertrain system of the follower e-pallet using the VTP.

In yet another embodiment, a follower e-pallet for use with a lead vehicle to which the follower e-pallet is connected in a platoon arrangement via a tether device includes an electric powertrain system connected to the set of road wheels and configured to provide an output torque thereto to propel the follower e-pallet, and a local controller connected to the follower e-pallet. The local controller is configured to receive, from a sensor suite, each of a measured length of the tether device, the azimuth angle, and a velocity of the follower e-pallet. The local controller is also configured to adaptively move the VTP on the leader e-pallet in response to the velocity, the azimuth angle, and the measured length, control a dynamic output state of the electric powertrain system using the VTP, and change a variable distance setpoint on the leader e-pallet to maintain a linear distance between the leader e-pallet and the follower e-pallet based on the azimuth angle.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 illustrates motor-driven electric pallets (“e-pallets”) in a platoon arrangement in which one or more trailing e-pallets (“followers”) are tethered to or in wireless communication with a lead vehicle (“leader”) and locally controlled in accordance with the present disclosure.

FIG. 2 is a schematic illustration of an electrified powertrain system usable as part of the followers shown in FIG. 1.

FIGS. 3A, 3B, and 3C illustrate exemplary motion trajectories of a platoon of e-pallets.

FIG. 4 is a schematic kinematic diagram of a representative follower usable as part of the exemplary platoon shown in FIG. 1.

FIGS. 5, 6, and 7 are schematic plan view illustrations of a platoon of e-pallets controller as set forth herein.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

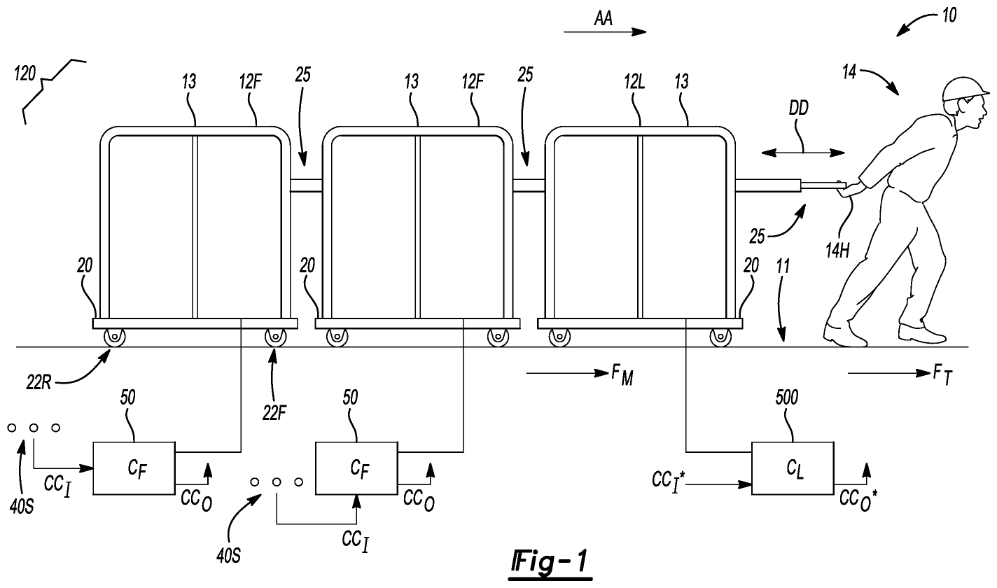

Referring to the drawings, wherein like reference numbers refer to like features throughout the several views, and beginning with FIG. 1, a workspace 10 is shown in which a platoon 120 of follower electric pallets (“e-pallets”) 12F trail a leader e-pallet 12L. In the non-limiting embodiment of FIG. 1, the follower e-pallets 12F are lightly tethered together and to the leader e-pallet 12L via a respective tether device 25. In various embodiments, the tether device 25 may be configured as a flexible device, or an extendable and contractable device such as a telescoping tube, or the tether device 25 can be made of strings. For simplicity, the e-pallets 12L and 12F are described below as “leader” and “follower”, respectively in such a tethered arrangement. However, those skilled in the art will appreciate that the present teachings may be used in platoons 120 in which the leader 12L is configured differently, e.g., as an operator-driven or autonomously controlled vehicle or a towing robot, without limitation. Likewise, the tether device 25 may be thought of as part of the follower 12F in some configurations, or the functions of the tether device 25 may be performed wirelessly, e.g., using radar systems, ultrasonics, one or more cameras, lidar systems, ultra-wide band (UWB) communications, etc. The platoon 120 is described below as utilizing the tether device 25 solely for illustrative consistency.

The platoon 120 of FIG. 1 may be used in a wide range of facilities, such as but not limited to manufacturing plants, warehouses, supply depots, and schools, for the purpose of assisting a human operator 14 in transporting a load within the workspace 10. Depending on the nature of the workspace 10 and of the various operations conducted therein, the load transported by the platoon 120 may be of various sizes, shapes, and constructions, e.g., products, cargo, raw materials, partially-assembled or fully-assembled parts or components, food, beverages, or other consumables, mail, packages, or other such items that may have to be moved within the workspace 10.

To enable the platoon 120 to function in this manner, the leader 12L and the follower(s) 12F are respectively equipped with a local controller (C_{L}) 500 and (C_{F}) 50. The local controller 500 receives input signals (arrow CC_{I}*), such as when the operator 14 applies a towing force (arrow FT). In response, the local controller 500 transmits motor control signals (arrow CC_{O}*) to one or more onboard electric traction motors to control propulsion functions of the leader 12L. The local controller 500 may regulate operation of the leader 12L using suitable closed-loop or open-loop dynamic control strategies informed by the input signals (arrow CC_{I}*). For instance, the leader 12L may be connected to the operator 14 by the flexible tether device 25, which the operator 14 may grasp when towing the platoon 120 in the direction of arrow AA. Regardless of how the lead e-pallet 12L is powered, however, the absence of vehicle-to-vehicle (V2V) communications within the platoon 120 of FIG. 1 ensures that the leader 12L cannot command actions of the follower(s) 12F.

Instead, the followers 12F act on their own, i.e., locally, doing so based on input signals (arrow CC_{I}) from a sensor suite 40S into the respective local controllers 50. The sensor suite 40S or constituent sensors thereof may be considered as part of the follower 12F or distinct therefrom in different embodiments. Aboard each one of the follower(s) 12F, the local controller 50 is mounted on or housed within a superstructure 13. The superstructure 13 may vary in its construction based on the transported load, but in general may embody a box-like container possibly including shelves, racks, bins, or other suitable structure for securely moving the load through the workspace 10. The superstructure 13 in turn is connected to or formed integrally with a base platform 20, e.g., a solid plate or planar surface of metal, plastic, and/or composite materials configured to support the collective weight of the local controller 50 and the above-described load. The base platform 20 in turn are connected to one or more road wheels 22F and 22R, e.g., via drive axles and a suspension system (not shown).

In the representative use case of FIG. 1, the operator 14 grasps the tether device 25 in the operator's hand 14H, with the tether device 25 in turn being pivotably and/or rotatably connected to the superstructure 13 of the follower 12F located immediately behind the leader 12L. The operator 14 pulls or tows the leader 12L in the general direction of arrow AA as the operator 14 walks through the workspace 10. The towing forces (arrow FT) are thus imparted to the leader 12L, thereby causing the leader 12L to move relative to a floor surface 11.

Depending on the relative velocities and ground speeds of the operator 14 and the leader 12L with respect to the floor surface 11, the tether device 25 extending to the leader 12L and grasped by the operator 14, as well as similar tether devices 25 connecting the follower(s) 12F together or to the leader 12L, may extend or contract in length, as indicated by double-headed arrow DD. At the same time, the local controller 50 of the follower(s) 12F and the local controller 500 of the leader 12L command a motor assist force (arrow FM), which is imparted by delivery of a motor drive torque to one or more of the road wheels 22F and/or 22R. Aboard the follower(s) 12F, this action is performed in response to the input signals (arrow CC_{I}) by the transmission of motor control signals (arrow CC_{O}) from the local controller 50, e.g., to corresponding motor control processors as appreciated in the art. The motor control signals (arrow CC_{O}) within the scope of the present disclosure may include a desired yaw rate (ω_{des}) and a desired velocity (V_{des}) of the follower(s) 12F, for instance.

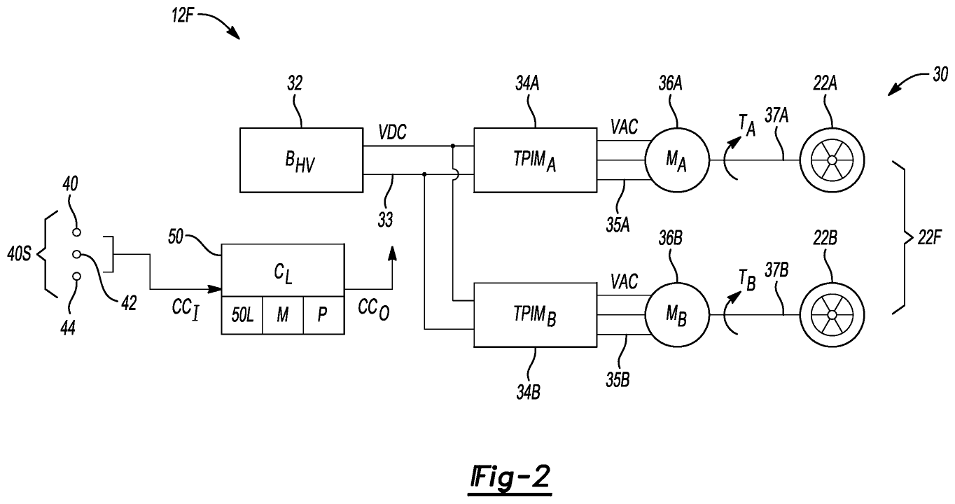

Referring briefly to FIG. 2, an electrified powertrain system 30 may be used to power the road wheels 22F of the follower(s) 12F of FIG. 1 in some implementations. Similar structure may be used to power the leader 12L, with possible differences in the composition of the input signals (arrow CC_{I}*) relative to the set of input signals (arrow CC_{I}) used by the local controller 50. The local controller 50 receives the input signals (arrow CC_{I}) from the sensor suite 40S, which is inclusive of a length sensor 40, an angle sensor 42, and a velocity sensor 44 as described below. The input signals (arrow CC_{I}) may be provided to the local controller 50 over a suitable hardwired transfer conductors or a wireless connection, e.g., a short distance BLUETOOTH®, Wi-Fi, or near-field communication (NFC) link.

In order to perform the various motion control functions, the local controller 50 is programmed in software and equipped with application-specific amounts of volatile and non-volatile memory (M) and one or more processor(s) (P). The memory (M) includes or is configured as a non-transitory computer readable storage device(s) or media, and may include volatile and nonvolatile storage in read-only memory (ROM) and random-access memory (RAM), and possibly keep-alive memory (KAM) or other persistent or non-volatile memory for storing various operating parameters while the processor (P) is powered down. Other implementations of the memory (M) may include, e.g., flash memory, solid state memory, PROM (programmable read-only memory), EPROM (electrically PROM), and/or EEPROM (electrically erasable PROM), and other electric, magnetic, and/or optical memory devices capable of storing data, at least some of which is used in the performance of the present method. The processors (P) may include various microprocessors or central processing units, as well as associated hardware such as a digital clock or oscillator, input/output (I/O) circuitry, buffer circuitry, Application Specific Integrated Circuits (ASICs), systems-on-a-chip (SoCs), electronic circuits, and other requisite hardware needed to provide the programmed functionality. In the context of the present disclosure, the local controller 50 executes instructions via the processor(s) (P) to cause the local controller 50 to perform the present method.

Computer-readable non-transitory instructions or code embodying the method and executable by the local controller 50 may include one or more separate software programs, each of which may include an ordered listing of executable instructions for implementing the stated logical functions described below. Execution of the instructions by the processor (P) in the course of operating the followers 12F causes the respective local controller(s) 50 to regulate motion of the followers 12F.

The electrified powertrain system 30 of FIG. 2 may include respective first and second road wheels 22A and 22B, e.g., arranged to function as oppositely-disposed front road wheels 22F of the follower 12F. The electrified powertrain system 30 in such a configuration may include a power supply 32, e.g., a multi-cell battery pack, which in a representative configuration may be configured as a rechargeable multi-cell battery having a lithium-ion or other suitable battery chemistry. The electrified powertrain system 30 also includes first and second traction power inverter modules (TPIM_{A}) 34A and (TPIM_{B}) 34B respectively connected to first and second electric traction motors (MA) 36A and (MB) 36B.

When the electric traction motors 36A and 36B are embodied as alternating current (AC)/polyphase propulsion motors as shown, the TPIMs 34A and 34B are connected to the power supply 32 via a direct current voltage bus 33. The TPIMs 34A and 34B are also connected to the electric motors 36A and 36B, respectively, via corresponding AC voltage busses 35A and 35B. Internal switching operations of the TPIMs 34A and/or 34B in this representative configuration is used to convert a DC voltage (VDC) present on the DC voltage bus 33 into an AC voltage (VAC) on the AC voltage bus 35A and/or 35B as needed in order to electrically energize one or both of the electric motors 36A and 36B. Embodiments may also be conceived of in which the electric motors 36A and 36B are DC motors, in which case one may omit the TPIMs 34A and 34B and associated power conversion circuitry.

With respect to locomotion of the follower 12F, each road wheel 22A and 22B may be separately powered by a respective output torque, i.e., arrows TA and TB. In such a configuration, the follower 12F may employ differential steering, which in turn is accomplished by rotating the road wheels 22A and 22B via corresponding output members 37A and 37B at different torques or speeds relative to one another. When executing a left-hand turn, for instance, the local controller 50 may command the output torque (TA) from the electric motor 36A at a higher level or corresponding rotary speed than the output torque (TB) from traction motor 36B. A similar steering effect may be enjoyed using a single electric traction motor 36A or 36B using an associated electronic differential, as will be appreciated by those skilled in the art, and therefore the configuration of FIG. 2 is merely representative of one possible embodiment of the electrified powertrain system 30.

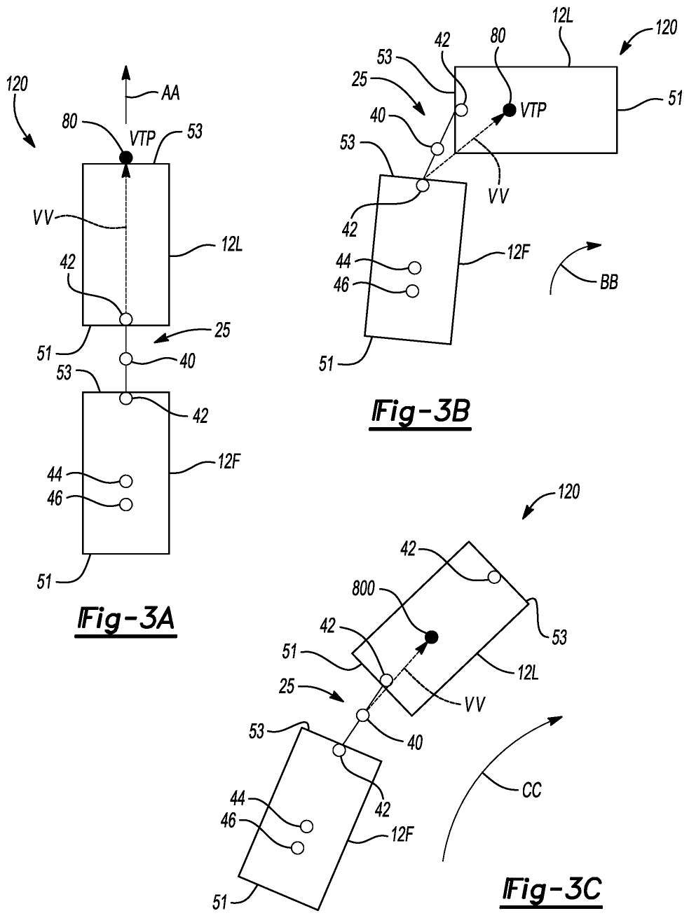

FIGS. 3A, 3B, and 3C show exemplary motion trajectories for the platoon 120 using the tether device 25 to connect the leader 12L to the follower 12F. In contemplated embodiments, the tether device 25 may be a flexible telescoping mechanism that axially extends or compresses depending on the relative velocities of the leader and followers 12L and 12F, respectively. Additionally, the tether device 25 pivots relative to the particular surface to which the tether device 25 is attached. For example, in FIG. 3A the tether device 25 is connected between a trailing edge 51 of the leader 12L and a leading edge 53 of the follower 12F. As an integral part of the tether device 25, or alternatively as an add-on component, the length sensor 40 disposed on or within the tether device 25 measures and reports the deployed length of the tether device 25 for use by the local controller 50 of FIG. 1 when controlling motion of the corresponding follower 12F. Additionally, an angle sensor 42 is disposed on the follower 12F and configured to measure an angle of articulation or azimuth angle, as part of the input signals (arrow CC_{I}), with the azimuth angle defined between the tether device 25 and the leading edge 53 of the follower 12F. Other sensors aboard the follower 12F may include one or more velocity sensors 44 and a yaw rate sensor 46, e.g., an inertial measurement unit (IMU), such that the local controller 50 is aware of the yaw rate and velocity of the follower 12F.

FIG. 3A represents simple straight-line motion of the platoon 120. Within the scope of the disclosure, the local controller 50 places a variable target point (VTP) 80 at an optimal location on the leader 12L. When the platoon 120 is traveling straight (arrow AA), the local controller 50 may place the VTP 80 on the leading edge 53 of the leader 12L as shown. Such placement makes the follower 12F less sensitive to the instantaneous readings from angle sensor 42, and hence more stable.

When the leader 12L begins to turn, however, as represented by arrow BB of FIG. 3B, the local controller 50 moves the VTP 80 toward the trailing edge 53 of the leader 12L. Such placement allows the follower 12F to more accurately track the motion of the leader 12L while at the same time avoiding the need for wide turns. For instance, as shown in the turn trajectory CC of FIG. 3C, use of a fixed target point 800 on the leader 12L leads to a higher turn radius relative to trajectory BB of FIG. 3B. As part of the disclosed strategy for control of the followers 12F, therefore, the local controller 50 is configured to adaptively move the VTP 80 in a manner conducive to balancing stability and ensuring desired tracking performance.

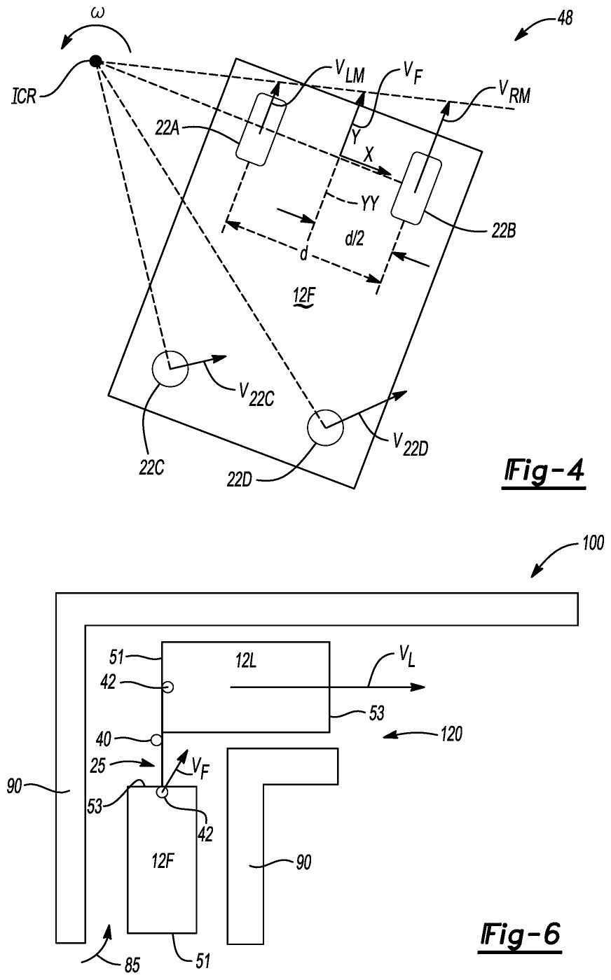

E-PALLET KINEMATICS: referring briefly to FIG. 4, a kinematics diagram 48 illustrates relevant parameters for consideration by the local controller 50 when performing the present control strategy. The follower 12F, shown in plan view in a nominal two-dimensional Cartesian xy coordinate frame and having a longitudinal centerline YY, includes the two powered road wheels 22A and 22B, which in turn are separated from each other by a distance (d). Thus, the distance between a given road wheel 22A or 22B and the centerline YY is d/2. Casters or other non-powered/passive wheels 22C, 22D may be used for the remaining road wheels 22C and 22D, as noted above, with corresponding velocity components V_{22C} and V_{22D}. In the representative FIG. 4 orientation, the road wheels 22A and 22B are respectively powered by a right motor and a left motor, i.e., the electric traction motors 36A and 36B of FIG. 2, with “right” and “left” being relative to a nominal forward-facing position of the operator 14. The respective motor velocities are thus represented by arrows V_{LM} and V_{RM}, which combine to produce a linear velocity (V_{F}) of the follower 12F. The follower 12F may also have a yaw rate (ω) about an instant center of rotation (ICR) as a point in free space, as understood in the art.

With continued reference to the representative diagram 48, the velocity (V_{F}) of the follower 12F may be expressed mathematically as V_{F}=\sqrt{\dot{x}²+\dot{y}²}, with the yaw rate (ω)=\dot{θ}. Additionally:

$${V}_{F} = \frac{{V}_{LM} + {V}_{RM}}{2}$$

$$ω = \frac{{V}_{RM} - {V}_{LM}}{d}$$

$$[ \begin{matrix}{V}_{RM} \\ {V}_{LM}\end{matrix} ] = {[ \begin{matrix}1 / 2 & 1 / 2 \\ \frac{1}{d} & - \frac{1}{d}\end{matrix} ]}^{- 1} [ \begin{matrix}{V}_{F} \\ ω\end{matrix} ]$$

$$[ \begin{matrix}{V}_{F} \\ ω\end{matrix} ] = [ \begin{matrix}1 / 2 & 1 / 2 \\ \frac{1}{d} & - \frac{1}{d}\end{matrix} ] [ \begin{matrix}{V}_{RM} \\ {V}_{LM}\end{matrix} ]$$

$$[ \begin{matrix}\dot{x} \\ \dot{y} \\ \dot{θ}\end{matrix} ] = [ \begin{matrix}cos θ \\ sin θ \\ 0\end{matrix} ] v + [ \begin{matrix}0 \\ 0 \\ 1\end{matrix} ] ω$$

Ultimately, the velocities of the left and right motors, i.e., the electric traction motors 36A and 36B, are expressed as functions of the velocity (V_{F}), the yaw rate (ω), and the distance (d) between the road wheels 22A and 22B:

$${V}_{LM} = {V}_{F} - \frac{ω d}{2}$$

$${V}_{RM} = {V}_{F} + \frac{ω d}{2}$$

The kinematics diagram 48 of FIG. 4 therefore represents a particular configuration of the follower 12F, one in which front steering is achieved in an exemplary instance via differential speeds of the road wheels 22A and 22B. Other embodiments may be contemplated within the scope of the present disclosure that use different versions of the kinematic diagram 48, such as embodiments in which the road wheels 22A and 22B are steerable using a steering assembly, and therefore the representation of FIG. 4 is intended to be illustrative of just one possible implementation.

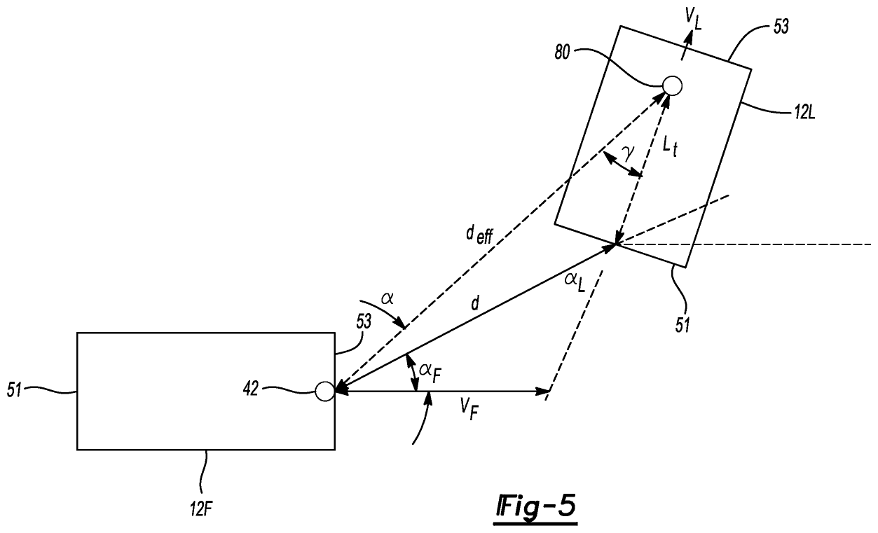

Functions of the local controller 50 in the overall control of the follower 12F will now be described with reference to FIGS. 5, 6, and 7. As noted above with particular reference to FIGS. 3A, 3B, and 3C, the local controller 50 is embodied as an electronic control unit connected to the follower 12F, e.g., mounted thereto or housed within the superstructure 13 shown in FIG. 1. As part of its programmed functionality, the local controller 50 is configured to adaptively move the VTP 80 of FIGS. 3A and 3B within a frame of reference on the leader 12L, with the local controller 50 doing so in response to the estimated velocity of the leader 12L, the azimuth angle between the follower 12F and the tether device 25, and the deployed length of the tether device 25 as measured by the length sensor 40. The local controller 50 thereafter controls a dynamic output state of the electric powertrain system 30 of the follower 12F using the VTP.

FIG. 5 schematically depicts the VTP 80 on the leader 12L, with the follower 12F moving with a velocity V_{F} and the leader 12L moving with a velocity V_{L}. The follower 12F is connected to the leader 12L by the above-described tether device 25, which is omitted for clarity. The linear distance (d) between the follower 12F and the leader 12L along the longitudinal axis of the tether device 25 is measured and reported by the length sensor 40 of FIGS. 2-3C. Relevant parameters include a target length (Lₜ) between the VTP 80 and the trailing edge 51 of the leader 12L, and an effective distance (d_{eff}) between the VTP 80 and the leading edge 53 of the follower 12F.

The local controller 50 is thus configured to calculate the target length (Lₜ) between the particular point at which the tether device 25 is connected to the leader 12L and the VTP 80, e.g., as follows:

Lₜ=Lₜ₀·cos(α_{L})

where α_{L} is the measured azimuth angle of the follower 12F from the point of view of the leader 12L, i.e., the angle between the tether device 25 and a connection point thereof on the trailing edge 51 of the leader 12L, and Lₜ₀ is the nominal value of the Lₜ that represents the distance to the VTP 80 for straight ahead driving/motion. Knowledge of the target length (Lₜ) allows the local controller 50 to calculate the angle (γ) between the VTP 80 and the connection point of the tether device 25 on the follower 12F, relative to the longitudinal axis of the leader 12L, for instance as follows:

$$γ = a tan ( \frac{d sin ( {α}_{L} )}{d cos ( {α}_{L} ) + {L}_{t}} )$$

The local controller 50 can thereafter derive the effective distance (d_{eff}) as a function of the above-described angle (γ), i.e.,:

$${d}_{eff} = \frac{d cos ( {α}_{L} ) + {L}_{t}}{cos ( γ )}$$

The corresponding azimuth angle (α) may then be calculated using the following equation:

α=α_{F}+α_{L}−γ

The local controller 50 is also programmed to change a distance setpoint based on the angle (γ). This additional capability allows the local controller 50 to adapt in real time to the limited range of motion of the tether device 25. By way of an illustration:

Distance setpoint=(r_{c}+Lₜ)·(1−k_{γ}γ)

Distance error=d_{eff}−distance setpoint

where r_{c} is a nominal following distance setpoint and k_{γ} is a calibration value. The local controller 50 can then control operation of the follower 12F in a closed loop to drive the distance error to zero.

Additional functionality of the local controller 50 includes the real-time estimation of the velocity of the leader 12L, which the local controller 50 then uses to define the desired velocity of the follower 12F. This allows the follower 12F to move in unison with the leader 12L, in the absence of a communication channel between the two:

V_{L}=V_{F} cos(α_{F}+α_{L})+\dot{d} cos(α_{L})

This capability allows the platoon 120 to corner sharply in tight spaces.

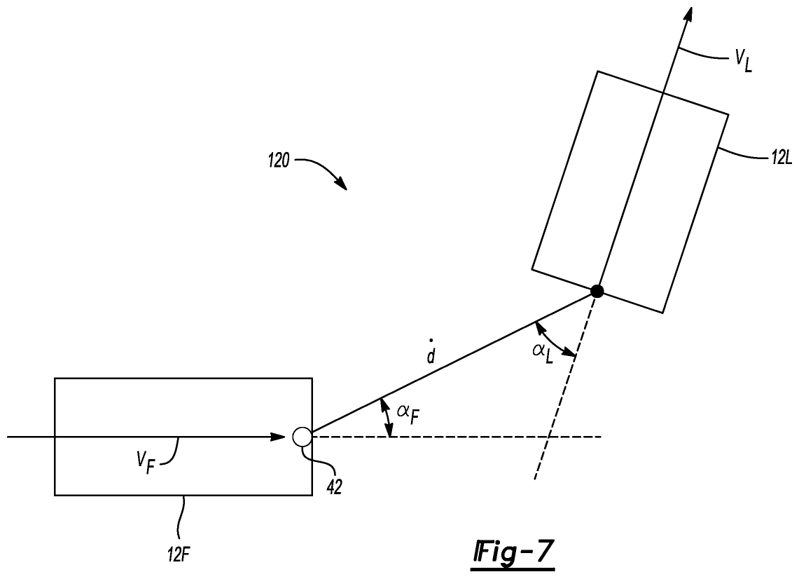

Referring now to FIG. 6, a representative corridor 100 is shown in which the platoon 120 negotiates a sharp turn in a hallway 85 demarcated by boundaries 90, e.g., walls, barriers, or simple lane markers or lines on a plant floor. Using the present control strategy, the follower 12F sets its desired velocity based on the estimated velocity of the leader 12L and the azimuth (α) to ensure that, during such a tight turn, the velocity V_{F} of the follower 12F does not overshoot. Avoidance of overshoot ensures that the follower 12F is not pushed off track, which in turn optimizes cornering in tight spaces as exemplified by corridor 100.

In terms of an associated velocity commands (V_{F_Cmd}) of the follower 12F, and with reference to FIG. 7, the local controller 50 of FIG. 2 calculates this value as a function of the above-described parameters:

V_{F_cmd}=V_{L}·cos(α_{L})=(V_{F} cos(α_{F}+α_{L})+\dot{d} cos(α_{L}))cos(α_{L}).

Calculation of the velocity commands in this manner allows the follower 12F to slow down or stop at intersections of the corridor 100 as needed to allow the leader 12L to complete its cornering. This capability allows the leader and follower to form a 90° articulation at right angle corners. The relative yaw dependent speed command thus ensures the follower 12F first corrects its own heading before speeding up.

The local controller 50 of FIG. 2 may also use a velocity term V_{F}² to provide a faster response at higher velocities of the platoon 120, so as to better compensate for a relatively slow response of the tether device 25. By way of an example calculation:

V_{cmd}=k_{d}·dₑᵣᵣₒᵣ+V_{F_cmd}

r_{cmd}=(k_{α}+k_{α,v}·V_{F}²)α+k_{α,d}·d·sin(α)

where k_{α}, k_{α,v} and k_{α,d} are calibratable gain constants. The velocity term also helps prioritize lateral motion correction over longitudinal motion correction, thereby overcoming non-holonomic constraint of the follower 12F.

The foregoing teachings may be implemented in method form, as will be appreciated by those skilled in the art. For instance, one may program the local controller 50 to execute instructions embodying a method for controlling the platoon 120 described in detail above. Such a method may include measuring, via the sensor suite 40S of FIGS. 1 and 2, a velocity of the follower 12F, an azimuth angle defined between the tether device 25 and the leading edge 53 of the follower 12F, and the length of the tether device 25. As part of such a method, the local controller 50 adaptively moves the VTP 80 on the leader 12L, doing so in response to the velocity, the azimuth angle, and the length. The local controller 50 thereafter controls a dynamic output state of the electric powertrain system 30 (FIG. 2) of the follower 12F using the VTP 80.

The solutions detailed above provide a number of controls and motion planning algorithms for control of the platoon 120 of lightly-tethered or wirelessly connected followers 12F constructed as e-pallets as set forth above. The platoon 120 may operate in a variety of environments often having tight turns, e.g., intersecting perpendicular hallways such as the corridor 100 of FIG. 6, which the platoon 120 might not otherwise be able to negotiate absent the present teachings. Thus, the ability to control the spacing, azimuth, and velocity of a follower 12F in an environment devoid of V2V communications, according to the foregoing strategy, greatly expands the utility of the platoon 120 and enables a more widespread adoption thereof in a host of industries. These and other attendant benefits will be readily appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A platoon of electric pallets (e-pallets), comprising:
a leader e-pallet;
a follower e-pallet arranged aft of the leader e-pallet to form the platoon of e-pallets, wherein an azimuth angle is defined between an axis of the leader e-pallet and a leading edge of the follower e-pallet;
a sensor suite, including a velocity sensor configured to measure a velocity of the follower e-pallet, an angle sensor configured to measure the azimuth angle, and a distance sensor configured to measure a distance between the leader e-pallet and the follower e-pallet, wherein follower e-pallet comprises:
a set of road wheels;
an electric powertrain system connected to the set of road wheels and configured to provide an output torque thereto; and
a local controller connected to the follower e-pallet, wherein the local controller is configured to adaptively move a variable target point (VTP) on the leader pallet in response to the velocity, the azimuth angle, and the distance, and to thereafter control a dynamic output state of the electric powertrain system using the VTP.

2. The platoon of claim 1, wherein the local controller is configured to change a variable distance setpoint on the leader e-pallet based on the azimuth angle to maintain a linear distance between the leader e-pallet and the follower e-pallet.

3. The platoon of claim 1, wherein the local controller is configured to estimate a velocity of the leader e-pallet as an estimated velocity, define a desired velocity of the follower e-pallet using the estimated velocity, and thereafter control the dynamic output state of the electric powertrain system of the follower e-pallet using the estimated velocity.

4. The platoon of claim 1, wherein the distance sensor includes a string potentiometer.

5. The platoon of claim 1, wherein the leader e-pallet is configured to be towed by a human operator, and the leader e-pallet includes motorized drive wheels responsive to a towing force imparted by the human operator.

6. The platoon of claim 1, wherein the set of road wheels includes a pair of front drive wheels, and the electric powertrain system includes first and second electric motors respectively connected to a different one of the front drive wheels to provide the follower e-pallet with a differential steering capability.

7. The platoon of claim 1, wherein the local controller is configured to use a velocity term to provide a faster response at higher velocities of the platoon to enable the local controller, and to compensate for a relatively slow response of the tether device.

8. The platoon of claim 1, wherein the follower e-pallet includes a plurality of follower e-pallets.

9. A method for controlling a platoon of electric pallets (e-pallets) having a leader e-pallet and a follower e-pallet connected thereto by a tether device, the follower e-pallet having a set of road wheels powered via an electric powertrain system, the method comprising:
measuring, via a plurality of sensors of a sensor suite, a velocity of the follower e-pallet, an azimuth angle defined between the tether device and a leading edge of the follower e-pallet, and a length sensor configured to measure a length of the tether device;
adaptively moving a variable target point (VTP) on the leader pallet, via a local controller of the follower e-pallet, in response to the velocity, the azimuth angle, and the length; and
controlling a dynamic output state of the electric powertrain system of the follower e-pallet using the VTP.

10. The method of claim 9, further comprising: changing a variable distance setpoint on the leader e-pallet based on the azimuth angle, via the follower controller, to thereby maintain a linear distance between the leader e-pallet and the follower e-pallet.

11. The method of claim 9, further comprising:
estimating a velocity of the leader e-pallet as an estimated velocity;
defining a desired velocity of the follower e-pallet using the estimated velocity; and
controlling the dynamic output state of the electric powertrain system using the estimated velocity.

12. The method of claim 11, wherein the set of road wheels includes a pair of front drive wheels, and the electric powertrain system includes first and second electric motors respectively connected to a different one of the front drive wheels, and wherein controlling the dynamic output state of the electric powertrain system using the estimated velocity includes turning the follower e-pallet using differential steering in which the first and second electric motors rotate at different output speeds relative to each other.

13. The method of claim 9, wherein the length sensor includes a string potentiometer that is integral with the tether device, and wherein measuring the length of the tether device is performed using the string potentiometer.

14. The method of claim 9, further comprising using a velocity term in logic of the local controller to provide a faster response at higher velocities of the platoon, and to thereby enable the local controller to compensate for a relatively slow response of the tether device.

15. The method of claim 9, wherein the follower e-pallet includes a plurality of follower e-pallets each having a respective electric powertrain system, and wherein controlling the dynamic output state of the electric powertrain system includes simultaneously controlling a respective dynamic output state of the respective electric powertrain system of each one of the follower e-pallets.

16. A follower electric pallet (e-pallet) for use with a lead vehicle to which the follower e-pallet is connected in a platoon arrangement via a tether device, the tether device defining an azimuth angle with respect to a leading edge of the follower e-pallet, the follower e-pallet comprising:
a set of road wheels;
an electric powertrain system connected to the set of road wheels and configured to provide an output torque thereto to propel the follower e-pallet; and
a local controller connected to the follower e-pallet, wherein the local controller is configured to receive from a sensor suite each of a measured length of the tether device, the azimuth angle, and a velocity of the follower e-pallet, and wherein the local controller is configured to:
adaptively move a variable target point (VTP) on the leader e-pallet in response to the velocity, the azimuth angle, and the measured length;
control a dynamic output state of the electric powertrain system using the VTP; and
change a variable distance setpoint on the leader e-pallet to maintain a linear distance between the leader e-pallet and the follower e-pallet based on the azimuth angle.

17. The follower e-pallet of claim 16, wherein the local controller is configured to estimate a velocity of the leader e-pallet as an estimated velocity, define a desired velocity of the follower e-pallet using the estimated velocity, and thereafter control the dynamic output state of the electric powertrain system of the follower e-pallet using the estimated velocity.

18. The follower e-pallet of claim 16, wherein the local controller is configured to use a velocity term in control logic of the local controller to provide a faster dynamic response of the follower e-pallet at higher velocities of the platoon to enable the local controller to compensate for a relatively slow response of the tether device.

19. The follower e-pallet of claim 16, further comprising the tether device.

20. The follower e-pallet of claim 19, further comprising the sensor suite, wherein the sensor suite includes a length sensor that is integral with the tether device.
